(19) United States
(12) Patent Application Publication
(10) Pub. No.: US 2024/0027565 A1
(43) Pub. Date: Jan. 25, 2024

(54) METHOD FOR MEASURING RELATIVE POSITION, NETWORK DEVICE AND NON-TRANSITORY COMPUTER-READABLE STORAGE MEDIUM

(71) Applicant: BEIJING XIAOMI MOBILE SOFTWARE CO., LTD., Beijing (CN)

(72) Inventor: Xiaowei JIANG, Beijing (CN)

(73) Assignee: BEIJING XIAOMI MOBILE SOFTWARE CO., LTD., Beijing (CN)

(21) Appl. No.: 18/265,244

(22) PCT Filed: Dec. 4, 2020
(86) PCT No.: PCT/CN2020/134063

§ 371 Date: Jun. 2, 2023

(51) Int. Cl. G01S 5/02

(52) U.S. Cl. CPC G01S 5/0236; G01S 5/0289

(57) ABSTRACT

A method for measuring a relative position, including: determining, by a first terminal, in response to priority information in a relative position measurement request sent by a second terminal, a first priority of the relative position measurement request; and determining whether to receive the relative position measurement request according to the first priority.

### CROSS REFERENCE

The present application is the U.S. National Stage of International Application No. PCT/CN2020/134063, filed on Dec. 4, 2020, all contents of which are incorporated herein by reference in its entirety for all purposes.

### BACKGROUND

A ranging-based service refers to a service that uses a relative distance and/or a relative angle between two terminals to provide a service. Among them, the relative angle generally refers to an angle of arrival (AOA) or an angle of departure (AOD). AOA represents the included angle between the received signal and the receiver antenna, and AOD represents the included angle between the transmitted signal and the transmitting antenna. The relative position between the two terminals may be determined by a combination of the relative distance and the relative angle, where a relative distance measurement and/or a relative angle measurement may be referred to as a relative position measurement.

### SUMMARY

The present disclosure relates, but is not limited, to a technical field of communication, and more particularly to a method for measuring a relative position, a network device, and a non-transitory computer-readable storage medium.

Embodiments of the first aspect of the present disclosure provide a method for measuring a relative position, including:
determining, by a first terminal, in response to priority information in a relative position measurement request sent by a second terminal, a first priority of the relative position measurement request; and
determining whether to receive the relative position measurement request according to the first priority.

Embodiments of a second aspect of the present disclosure provide a network device, including: a transceiver; a memory; and a processor, respectively connected to the transceiver and the memory, configured to control wireless signal transmission and reception of the transceiver by executing a computer executable instruction on the memory, and enable to implement the above-mentioned method.

Embodiments of a third aspect of the present disclosure provide a non-transitory computer-readable storage medium is provided, where, the non-transitory computer-readable storage medium stores a computer-executable instruction, and after the computer-executable instruction is executed by a processor, the above-mentioned method is enabled to be implemented.

Additional aspects and advantages of the present disclosure will be given in the following description part, and will partially become apparent from the following description, or will be learned through practice of the present disclosure.

### BRIEF DESCRIPTION OF THE DRAWINGS

The above and/or additional aspects and advantages of the present disclosure will become apparent and readily appreciated from the following description of embodiments in conjunction with the accompanying drawings, in which:

FIG. 1 is a schematic flowchart of a method for measuring a relative position according to some embodiments of the present disclosure;

FIG. 2 is a schematic flowchart of another method for measuring a relative position according to some embodiments of the present disclosure;

FIG. 3 is a schematic flowchart of another method for measuring a relative position according to some embodiments of the present disclosure;

FIG. 4 is a schematic flowchart of another method for measuring a relative position according to some embodiments of the present disclosure;

FIG. 5 is a schematic flowchart of another method for measuring a relative position according to some embodiments of the present disclosure;

FIG. 6 is a schematic flowchart of another method for measuring a relative position according to some embodiments of the present disclosure;

FIG. 7 is a schematic structural diagram of an apparatus for measuring a relative position according to some embodiments of the present disclosure;

FIG. 8 is a schematic structural diagram of another apparatus for measuring a relative position according to some embodiments of the present disclosure;

FIG. 9 is a schematic structural diagram of another apparatus for measuring a relative position according to some embodiments of the present disclosure;

FIG. 10 is a schematic structural diagram of another apparatus for measuring a relative position according to some embodiments of the present disclosure;

FIG. 11 is a schematic structural diagram of a network device according to some embodiments of the present disclosure.

### DETAILED DESCRIPTION

Embodiments of the present disclosure are described in detail below, examples of which are shown in the accompanying drawings, where the same or similar reference numbers are used to refer to the same or similar elements or elements having the same or similar functions. The embodiments described below with reference to the drawings are exemplary, and are intended to explain the present disclosure and cannot be understood as limitations to the present disclosure.

In an actual application, the terminal may be performing a plurality of relative position measurement processes. If a new relative position measurement request is obtained, the terminal needs to determine whether to perform a new relative position measurement process, or to continue to perform the ongoing relative position measurement process.

For this problem, embodiments of the present disclosure provide a method and apparatus for measuring a relative position.

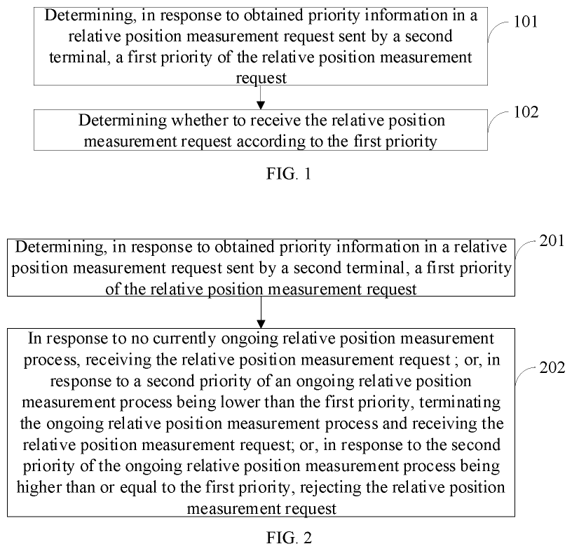

FIG. 1 is a schematic flowchart of a method for measuring a relative position according to some embodiments of the present disclosure. The method may be executed by a first terminal, where the first terminal may be a device such as a mobile phone, a palm computer, a wearable device, a smart home appliance, and the like, so as to determine whether to receive the relative position measurement request or not, according to the first priority of the relative position measurement request sent by a second terminal.

As shown in FIG. 1, the method for measuring the relative position includes the following steps.

In step 101, in response to obtained priority information in a relative position measurement request sent by the second terminal, a first priority of the relative position measurement request is determined.

In some embodiments, if the second terminal needs to obtain a ranging-based service, it may send a relative position measurement request to the first terminal, and the first terminal obtains the relative position measurement request sent by the second terminal. Among, them, the relative position measurement request may be a relative distance measurement request and/or a relative angle measurement request, and the relative position measurement request may include a service type to which the ranging-based service that needs to be obtained by the second terminal belongs.

Here, the second terminal may be a device such as a mobile phone, a palm computer, a wearable device, a smart home appliance, and the like. The second terminal may be a device having the same type as the first terminal, such as a mobile phone, or a device of different types. For example, the first terminal is a mobile phone, and the second terminal is an intelligent air conditioner.

In some embodiments, the first terminal determines a first priority of the relative position measurement request in response to the obtained priority information in the relative position measurement request sent by the second terminal. For example, the first priority of the relative position measurement request may be determined according to the priority of the service type corresponding to the relative position measurement request sent by the second terminal, where the higher the priority of the service type, the higher the first priority.

In step 102, according to the first priority, whether to receive the relative position measurement request is determined.

In some embodiments, after determining the first priority of the relative position measurement request of the second terminal, whether to receive the relative position measurement request may be determined according to the first priority. For example, in response to the first priority being higher than the second priority of any ongoing relative position measurement process, the first terminal receives the relative position measurement request of the second terminal.

The method for measuring the relative position of the embodiments of the present disclosure is applied to the first terminal. In response to the obtained priority information in the relative position measurement request sent by the second terminal, the first priority of the relative position measurement request is determined, and whether to receive the relative position measurement request is determined according to the first priority. Thus, the terminal determines whether to receive the new relative position measurement request according to the priority of the new relative position measurement request.

In some embodiments of the present disclosure, when the first terminal determines whether to receive the relative position measurement request of the second terminal, the first terminal may further determine whether to receive the relative position measurement request of the second terminal according to the number of simultaneous relative position measurement processes supported by the first terminal, the number of ongoing relative position measurement processes, and the like.

Among them, the number of simultaneous relative position measurement processes supported by the first terminal may be set according to the processing capability of the first terminal.

In some embodiments, the first terminal may receive the relative position measurement request of the second terminal in response to the number of simultaneous relative position measurement processes supported by the first terminal being greater than the number of ongoing relative position measurement processes.

In some embodiments, in response to the number of simultaneous relative position measurement processes supported by the first terminal being equal to the number of ongoing relative position measurement processes, it is indicated that the number of simultaneous relative position measurement processes by the first terminal has been saturated, and the first terminal may reject the relative position measurement request of the second terminal.

In some embodiments of the present disclosure, the first terminal may determine whether to receive the relative position measurement request of the second terminal according to the number of simultaneous relative position measurement processes supported by the first terminal, the number of ongoing relative position measurement processes, and the like.

In some embodiments of the present disclosure, in response to the obtained priority information in the relative position measurement request sent by the second terminal, the first terminal determines a first priority of the relative position measurement request, and determines at the same time whether to receive the relative position measurement request of the second terminal according to the first priority, the number of simultaneous relative position measurement processes supported by the first terminal and the number of ongoing relative position measurement processes.

In some embodiments, in response to the number of simultaneous relative position measurement processes supported by the first terminal being equal to the number of ongoing relative position measurement processes and a second priority of any ongoing relative position measurement process being lower than the first priority, the first terminal may terminate any ongoing relative position measurement process and receive the relative position measurement request of the second terminal.

In some embodiments, in response to the number of simultaneous relative position measurement processes supported by the first terminal being equal to the number of ongoing relative position measurement processes and the second priorities of the ongoing relative position measurement processes being all higher than the first priority, the first terminal may reject the relative position measurement request of the second terminal.

In the embodiments of the present disclosure, according to the first priority of the relative position measurement request of the second terminal, the number of simultaneous relative position measurement processes supported by the first terminal, and the number of ongoing relative position measurement processes, the first terminal may determine at the same time whether to receive the relative position measurement request, so that the terminal can determine whether to receive the new relative position measurement request according to the priority of the new relative position measurement request and its own processing capability.

FIG. 2 is a schematic flowchart of another method for measuring a relative position according to some embodiments of the present disclosure. The method for measuring the relative position can be executed by the first terminal, so as to determine whether to receive the relative position measurement request according to the first priority of the relative position measurement request.

As shown in FIG. 2, the method for measuring the relative position includes the following steps.

In step 201, in response to obtained priority information in a relative position measurement request sent by the second terminal, a first priority of the relative position measurement request is determined.

In the related art, an edge connection sidelink interface between a terminal and another terminal is referred to as a PC5 interface based on a direct connection between objects sidelink technology. Among them, the sidelink control plane may support the following two protocols, a PC5-Signaling (PC5-S) protocol and an RRC protocol.

In some embodiments, the second terminal may carry the relative position measurement request through a PC5 RRC message or a PC5 schematic message, and send the relative position measurement request to the first terminal.

In some embodiments, the priority information may include at least one of service-related information and a service priority.

In some embodiments, the priority information includes service priority information. In response to the service priority information in the priority information, the first terminal determines the first priority of the relative position measurement request sent by the second terminal. Among them, the higher the service priority, the higher the first priority of the relative position measurement request.

In some embodiments, the priority information includes service-related information. In response to the service-related information in the priority information, the first terminal may determine the first priority of the relative position measurement request sent by the second terminal.

In some embodiments, the service-related information may include at least one of an operating system identification, an application identification, a service type, a latency requirement, and the like. Among them, the operating system identification is an identification of an operating system of the second terminal; the application identification is an identification of an application that sends the relative position measurement request in the second terminal; and the service type is a service type to which the service that needs to measure the position belongs, for example, the service type is an emergency service, an Internet of Vehicles service, a smart home service, etc.

The first terminal may determine the first priority of the relative position measurement request in response to the latency requirement in the first priority message information, where the higher the latency requirement, the higher the first priority of the relative position measurement request. Or, the first terminal may determine the first priority of the relative position measurement request in response to the operating system identification in the first priority message information and the operating system identification of the first terminal. For example, the determined first priority when the operating system of the second terminal is the same as the operating system of the first terminal, is higher than the determined first priority when the operating system of the second terminal is different from the operating system of the first terminal.

In step 202, in response to no currently ongoing relative position measurement process, the relative position measurement request is received; or, in response to a second priority of an ongoing relative position measurement process being lower than the first priority, the ongoing relative position measurement process is terminated and the relative position measurement request is received; or, in response to the second priority of the ongoing relative position measurement process being higher than or equal to the first priority, the relative position measurement request is rejected.

In some embodiments, the first terminal may receive the relative position measurement request of the second terminal in response to no currently ongoing relative position measurement process.

In some embodiments, in response to the second priority of the ongoing relative position measurement process being lower than the first priority, the first terminal may terminate the ongoing relative position measurement process, and receive the relative position measurement request of the second terminal, where the ongoing relative position measurement process with the second priority being lower than the first priority may be one or more.

In some embodiments, in response to the second priority of the ongoing relative position measurement process being higher than or equal to the first priority, the first terminal may reject the relative position measurement request of the second terminal.

In some embodiments, in response to rejecting the relative position measurement request of the second terminal, the first terminal may return a rejection message to the second terminal, where the rejection message includes a rejection reason. For example, the rejection reason is that the priority is lower than that of the ongoing relative position measurement process. Thus, the second terminal may obtain the reason why the first terminal rejects its relative position measurement request.

In some embodiments, in response to rejecting the relative position measurement request of the second terminal, the first terminal may return a rejection message to the second terminal, where the rejection message includes a waiting duration to instruct the second terminal to initiate the relative position measurement request again after the waiting duration. Thus, the second terminal may send the relative position measurement request to the first terminal again according to the rejection message after the waiting duration.

Among them, the waiting duration may be determined by the first terminal according to the number of ongoing relative position measurement processes.

In some embodiments, in response to rejecting the relative position measurement request of the second terminal, the rejection message returned by the first terminal to the second terminal may also include information such as the rejection reason and the waiting duration.

According to the method for measuring the relative position of the embodiments of the present disclosure, in response to the obtained priority information in the relative position measurement request sent by the second terminal, the first priority of the relative position measurement request is determined; in response to no currently ongoing relative position measurement process, the relative position measurement request is received; or, in response to a second priority of an ongoing relative position measurement process being lower than the first priority, the ongoing relative position measurement process is terminated and the relative position measurement request is received; or, in response to the second priority of the ongoing relative position measurement process being higher than or equal to the first priority, the relative position measurement request is rejected. Thus, the terminal determines whether to receive the new relative position measurement request according to the priority of the new relative position measurement request.

In some embodiments of the present disclosure, the first terminal may further obtain priority configuration information sent by a network element, where the configuration information includes service-related information and corresponding priority information. Each piece of service-related information may include at least one of an operating system identification, an application identification, a service type, a latency requirement, etc.

In some embodiments, the first terminal may determine the first priority of the relative position measurement request according to the priority configuration information and the relative position measurement request of the second terminal, and determine whether to receive the relative position measurement request of the second terminal according to the first priority.

For example, the priority configuration information includes a service type and a priority corresponding to each service type. According to the service type carried in the relative position measurement request and the service type and the corresponding priority included in the priority configuration information, The first terminal may determine a priority corresponding to the service type carried in the relative position measurement request, and determine the first priority of the relative position measurement request according to the priority corresponding to the service type carried in the relative position measurement request.

For example, the priority configuration information includes three types of service types A, B, and C, where the priority of the service type A is the highest, the priority of B takes second place, and the priority of C is the lowest. The service type carried in the relative position measurement request of the second terminal is A. The first terminal may determine that the priority of the relative position measurement request is the highest priority according to the service types A, B, C and the corresponding priority, and the service type A carried in the relative position measurement request.

According to the method for measuring the relative position of the embodiments of the present disclosure, the priority configuration information sent by the network element is obtained, the first priority of the relative position measurement request is determined based on the priority configuration information and the priority information in the relative position measurement request sent by the second terminal, and whether to receive the relative position measurement request is determined according to the first priority, so that whether to receive the new relative position measurement request is determined based on the configuration information sent by the network element.

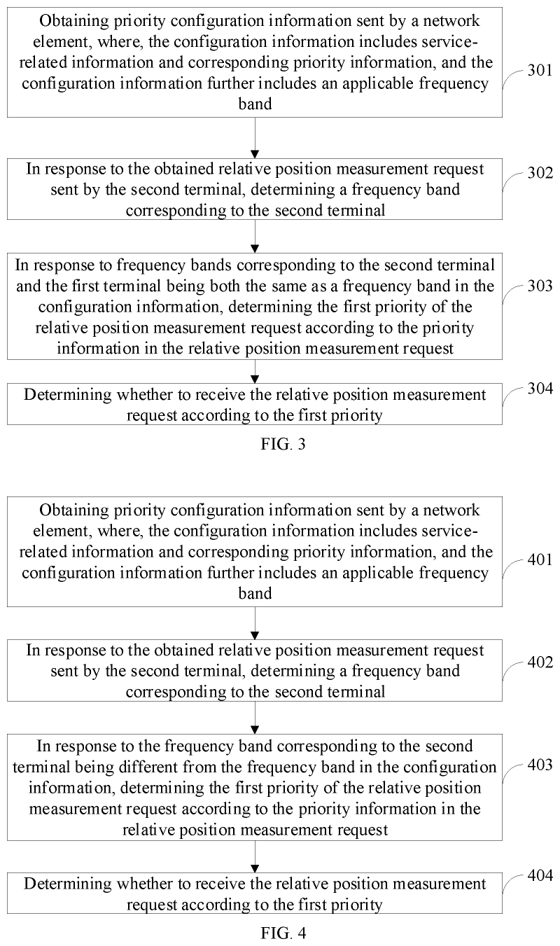

In some embodiments of the present disclosure, according to the frequency bands respectively corresponding to the first terminal and the second terminal, the first terminal may also determine whether to receive the relative position measurement request according to the first priority. The following is described in conjunction with FIG. 3 and FIG. 4. FIG. 3 is a schematic flowchart of another method for measuring a relative position according to some embodiments of the present disclosure, and the method may be executed by a first terminal.

As shown in FIG. 3, the method for measuring the relative position includes the following steps.

In step 301, priority configuration information sent by a network element is obtained, where, the configuration information includes service-related information and corresponding priority information, and the configuration information further includes an applicable frequency band.

In some embodiments, the first terminal may obtain the priority configuration information sent by the network element, where the priority configuration information sent by the network element may include service-related information and corresponding priority information, and may further include an applicable frequency band that may be provided by the network element.

In some embodiments, the applicable frequency band included in the priority configuration information may be one or more.

In step 302, in response to the obtained relative position measurement request sent by the second terminal, a frequency band corresponding to the second terminal is determined.

In some embodiments, the relative position measurement request sent by the second terminal may include information such as a frequency band corresponding to the second terminal and a service type. In response to the obtained relative position measurement request sent by the second terminal, a frequency band corresponding to the second terminal may be determined.

In step 303, in response to the frequency bands corresponding to the second terminal and the first terminal being both the same as a frequency band in the configuration information, the first priority of the relative position measurement request is determined according to the priority information in the relative position measurement request.

In some embodiments, the first terminal compares the frequency band corresponding to itself and the frequency band corresponding to the second terminal with the frequency band in the configuration information. In response to the frequency bands corresponding to the second terminal and the first terminal being both the same as the frequency band in the configuration information, the first terminal determines the first priority of the relative position measurement request according to the priority information in the relative position measurement request.

In some embodiments, if the configuration information includes a plurality of frequency bands, the frequency bands corresponding to the second terminal and the first terminal being both the same as the frequency band in the configuration information may be that the frequency bands corresponding to the first terminal, and the second terminal are the same and the corresponding frequency bands are the frequency bands in the configuration information, or maybe that the frequency band corresponding to the first terminal is different from the frequency band corresponding to the second terminal, and the frequency band corresponding to the first terminal and the frequency band corresponding to the second terminal are both the frequency bands in the configuration information.

In some embodiments, the first priority of the relative position measurement request is determined according to the priority information in the relative position measurement request, which may be implemented by respectively using any one of the embodiments of the present disclosure. The embodiments of present disclosure do not limit to this, and will not describe it again.

In step 304, whether to receive the relative position measurement request is determined according to the first priority.

In the embodiments of the present disclosure, step 304 may be implemented by respectively using any one of the embodiments of the present disclosure. The embodiments of present disclosure do not limit to this, and will not describe it again.

In some embodiments, in response to rejecting the relative position measurement request of the second terminal, the first terminal may return a rejection message to the second terminal, where the rejection message includes a rejection reason. For example, the rejection reason is that the priority of the relative position measurement request is lower than that of the ongoing relative position measurement process. Thus, the second terminal may obtain the reason why the first terminal rejects its relative position measurement request.

In some embodiments, in response to rejecting the relative position measurement request of the second terminal, the first terminal may return a rejection message to the second terminal, where the rejection message includes a waiting duration to instruct the second terminal to initiate the relative position measurement request again after the waiting duration. Thus, the second terminal may send the relative position measurement request to the first terminal again according to the rejection message after the waiting duration.

Among them, the waiting duration may be determined by the first terminal according to the number of the ongoing relative position measurement processes.

In some embodiments, in response to rejecting the relative position measurement request of the second terminal, the rejection message returned by the first terminal to the second terminal may also include information such as the rejection reason and the waiting duration.

According to the method for measuring the relative position of the embodiments of the present disclosure, the priority configuration information sent by the network element is obtained, where the configuration information may further include an applicable frequency band. In response to the frequency bands corresponding to the second terminal and the first terminal being both the same as the frequency band in the configuration information, whether to receive the new relative position measurement request is determined by using the priority of the relative position measurement request.

FIG. 4 is a schematic flowchart of another method for measuring a relative position according to some embodiments of the present disclosure, and the method may be executed by a first terminal.

As shown in FIG. 4, the method for measuring the relative position includes the following steps.

In step 401, priority configuration information sent by a network element is obtained, where, the configuration information includes service-related information and corresponding priority information, and the configuration information further includes an applicable frequency band.

In some embodiments, step 401 may be implemented by respectively using any one of the embodiments of the present disclosure. The embodiments of present disclosure do not limit to this, and will not describe it again.

In step 402, in response to the obtained relative position measurement request sent by the second terminal, a frequency band corresponding to the second terminal is determined.

In some embodiments, step 402 may be implemented by respectively using any one of the embodiments of the present disclosure. The embodiments of present disclosure do not limit to this, and will not describe it again.

In step 403, in response to the frequency band corresponding to the second terminal being different from the frequency band in the configuration information, the first priority of the relative position measurement request is determined according to the priority information in the relative position measurement request.

In some embodiments, the first terminal may compare the frequency band corresponding to the second terminal with the frequency band in the configuration information. In response to the frequency band corresponding to the second terminal being different from the frequency band in the configuration information, the first terminal may determine the first priority of the relative position measurement request according to the priority information in the relative position measurement request.

If the configuration information includes a plurality of frequency bands, the frequency band corresponding to the second terminal being different from the frequency band in the configuration information may be that the frequency band corresponding to the second terminal is different from each frequency band in the configuration information. That is, the frequency band used by the second terminal is not the frequency band in the configuration information.

In some embodiments, the first priority of the relative position measurement request is determined according to the priority information in the relative position measurement request, which may be implemented by respectively using any one of the embodiments of the present disclosure. The embodiments of present disclosure do not limit to this, and will not describe it again.

In step 404, whether to receive the relative position measurement request is determined according to the first priority.

In some embodiments, step 404 may be implemented by respectively using any one of the embodiments of the present disclosure. The embodiments of present disclosure do not limit to this, and will not describe it again.

In some embodiments, in response to rejecting the relative position measurement request of the second terminal, the first terminal may return a rejection message to the second terminal, where the rejection message includes a rejection reason. For example, the rejection reason is that the priority is lower than that of the ongoing relative position measurement process. Thus, the second terminal may obtain the reason why the first terminal rejects its relative position measurement request.

In some embodiments, in response to rejecting the relative position measurement request of the second terminal, the first terminal may return a rejection message to the second terminal, where the rejection message includes a waiting duration to instruct the second terminal to initiate the relative position measurement request again after the waiting duration. Thus, the second terminal may send the relative position measurement request to the first terminal again according to the rejection message after the waiting duration.

Among them, the waiting duration may be determined by the first terminal according to the number of the ongoing relative position measurement processes.

In some embodiments, in response to rejecting the relative position measurement request of the second terminal, the rejection message returned by the first terminal to the second terminal may also include information such as the rejection reason and the waiting duration.

According to the method for measuring the relative position of the embodiments of the present disclosure, the priority configuration information sent by the network element is obtained, where the configuration information may further include an applicable frequency band. In response to the frequency band corresponding to the second terminal being different from the frequency band in the configuration information, whether to receive the new relative position measurement request is determined by using the priority of the relative position measurement request.

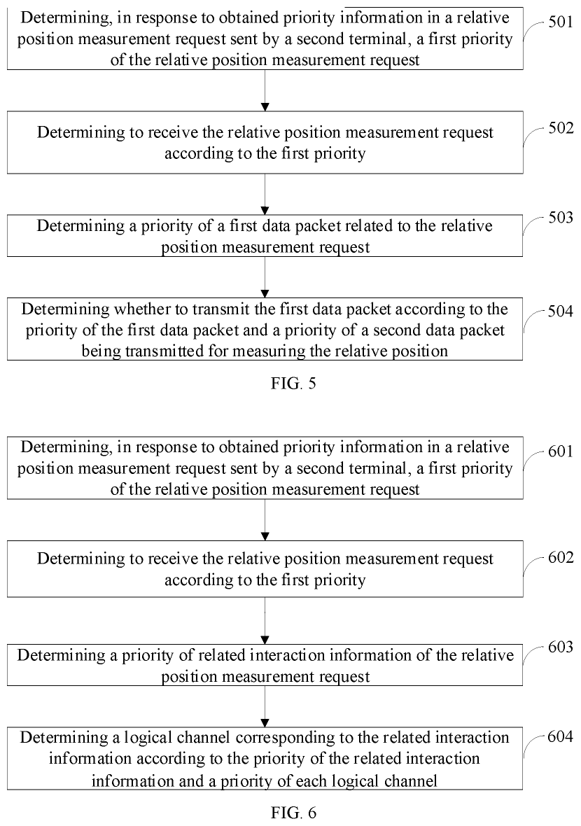

FIG. 5 is a schematic flowchart of another method for measuring a relative position according to some embodiments of the present disclosure, and the method may be executed by a first terminal.

As shown in FIG. 5, the method for measuring the relative position includes the following steps.

In step 501, in response to obtained priority information in a relative position measurement request sent by the second terminal, a first priority of the relative position measurement request is determined.

In some embodiments, step 501 may be implemented by respectively using any one of the embodiments of the present disclosure. The embodiments of present disclosure do not limit to this, and will not describe it again.

In step 502, it is determined to receive the relative position measurement request according to the first priority.

In some embodiments, step 502 may be implemented by respectively using any one of the embodiments of the present disclosure. The embodiments of present disclosure do not limit to this, and will not describe it again.

In step 503, a priority of a first data packet related to the relative position measurement request is determined.

In some embodiments, after receiving the relative position measurement request of the second terminal, the first terminal may send a first data packet related to the relative position measurement request on the physical layer. Among them, the first data packet may be a data packet related to physical layer channel scheduling.

In some embodiments, the first data packet sent by the first terminal on the physical layer may carry the priority information, so that the priority of the first data packet related to the relative position measurement request may be determined according to the priority information carried in the first data packet.

In some embodiments, the first terminal may also determine the priority of the first data packet related to the relative position measurement request according to the first priority of the relative position measurement request. Among them, the higher the priority of the relative position measurement request, the higher the priority of the first data packet.

In step 504, whether to transmit the first data packet is determined according to the priority of the first data packet and a priority of a second data packet being transmitted for measuring the relative position.

In some embodiments, in response to the first data packet being transmitted simultaneously with the second data packet being transmitted for measuring the relative position, whether to transmit the first data packet may be determined according to the priority of the first data packet and the priority of the second data packet being transmitted for measuring the relative position.

In some embodiments, in response to the priority of the first data packet related to the relative position measurement request being lower than or equal to the priority of the second data packet being transmitted, the physical layer of the first terminal may reject to transmit the first data packet and continue to transmit the second data packet.

In some embodiments, in response to the priority of the first data packet related to the relative position measurement request being higher than the priority of the second data packet, the physical layer of the first terminal may terminate the transmission of the second data packet, and start to transmit the first data packet related to the relative position request measurement.

According to the method for measuring the relative position of the embodiments of the present disclosure, according to the priority of the first data packet related to the relative position measurement request and the priority of the second data packet being transmitted for measuring the relative position, whether to transmit the first data packet is determined, so that the data packet related to the relative position measurement request is transmitted according to the priority of the data packet.

FIG. 6 is a schematic flowchart of another method for measuring a relative position according to some embodiments of the present disclosure, and the method may be executed by a first terminal.

As shown in FIG. 6, the method for measuring the relative position includes the following steps.

In step 601, in response to obtained priority information in a relative position measurement request sent by the second terminal, a first priority of the relative position measurement request is determined.

In some embodiments, step 601 may be implemented by respectively using any one of the embodiments of the present disclosure. The embodiments of present disclosure do not limit to this, and will not describe it again.

In step 602, it is determined to receive the relative position measurement request according to the first priority.

In some embodiments, step 602 may be implemented by respectively using any one of the embodiments of the present disclosure. The embodiments of present disclosure do not limit to this, and will not describe it again.

In step 603, a priority of related interaction information of the relative position measurement request is determined.

In some embodiments, the related interaction information refers to information that the first terminal performs interaction with the second terminal during the relative position measurement process according to the relative position measurement request. For example, the related interaction information may include information actively sent by the first terminal to the second terminal for measuring the relative position, a response returned by the second terminal to the first terminal, a relative position measurement result returned by the first terminal to the second terminal, etc.

In some embodiments, the first terminal may determine the priority of each piece of related interaction information according to the function of the related interaction information in the relative position measurement process.

In step 604, a logical channel corresponding to the related interaction information is determined according to the priority of the related interaction information and a priority of each logical channel.

In some embodiments, the first terminal may specify different priorities for different logical channels. The first terminal may determine, according to the priority of the related interaction information and the priority of each logical channel, a logical channel corresponding to the related interaction information. Among them, the higher the priority of the related interaction information, the higher the priority of the logical channel corresponding to the related interaction information.

After determining the logical channel corresponding to the related interaction information, the first terminal may use each piece of related interaction information of the logical channel corresponding to each piece of related interaction information, so that the first terminal may use a separate logical channel to send the related interaction information during the relative position measurement process.

In the embodiments of the present disclosure, the logic channel corresponding to the related interaction information is determined according to the priority of the related interaction information and the priority of each logic channel, so that the priority between the related interaction information is controlled according to the priority of the related interaction information and the priority of each logic channel.

The following are examples of the above embodiments.

The terminal a sends an angle measurement/distance measurement request to the terminal b, where the request message carries priority information. After receiving the request message of the terminal a, the terminal b may reject the distance measurement/angle measurement request if there is a currently ongoing distance measurement/angle measurement process with a higher priority than the request.

If the terminal b has a currently ongoing distance measurement/angle measurement process with a lower priority than the request, then the terminal b may receive the distance measurement/angle measurement request and terminate the ongoing distance measurement/angle measurement process.

If the terminal b has an ongoing distance measurement/angle measurement process and supports simultaneous distance measurement/angle measurement for this request, the terminal b may receive the distance measurement/angle measurement request.

Among them, the distance measurement/angle measurement priority information includes a service priority and/or a latency requirement. The higher the service priority, the lower the latency, and the higher the corresponding distance measurement/angle measurement priority.

In some embodiments, the distance measurement/angle measurement request is sent through a PC5 RRC message or a PC5-S message (denoted as a PC5 schematic message). When the application layer of the terminal a requests distance measurement/angle measurement from the PC5-S layer, the application layer of the terminal a provides service-related information or priority information to the PC5-S layer of the terminal b.

Among them, the service-related information includes one or more of the following: an OS ID (denoted as an operating system identification), an APP ID (denoted as an application identification), a service type (such as an emergency service, an Internet of Vehicles service, a smart home service, etc.), a latency requirement, etc.

The PC5-S layer provides the distance measurement/angle measurement priority information to the PC5-RRC layer when performing the distance measurement/angle measurement request.

In some embodiments, the core network element (such as an AMF) may configure the priority information provided to the terminal b. The priority information includes an OS ID (operating system identification), an APP ID (application identification), and corresponding priority information.

When performing distance measurement/angle measurement by using the frequency provided by the service provider, the terminal a and the terminal b use the priority information.

The SCI (sidelink control information) related to the distance measurement/angle measurement process (i.e., the first data packet related to the relative position measurement request) sent by the terminal b on the physical layer, carries the priority information. Among them, the SCI is used to send information related to physical layer sidelink channel scheduling. If the priority of the distance measurement/angle measurement related information to be currently transmitted is higher than the priority of the currently ongoing distance measurement/angle measurement transmission, the physical layer of the terminal b may decide to terminate the current transmission and send the distance measurement/angle measurement transmission; otherwise, the physical layer of the terminal b may continue with the current transmission.

The message interaction related to the distance measurement/angle measurement between the terminal a and the terminal b is sent by using a separate logical channel and optionally a separate SRB/DRB (signaling carrier/data carrier), and a plurality of distance measurement/angle measurement processes between the terminal a and the terminal b may also use a separate logical channel and optionally a separate SRB/DRB, respectively. Thus, the terminal may specify different priorities for different logical channels, so as to implement priority control between different distance measurement/angle measurement processes, and between distance measurement/angle measurement interactions and other data/signaling information.

If the terminal b rejects the distance measurement/angle measurement request of the terminal a due to the fact that there is a distance measurement/angle measurement process with a higher priority currently, the terminal b indicates a rejection reason in the rejection message, for example, there is a distance measurement/angle measurement process with a higher priority.

If the terminal b rejects the distance measurement/angle measurement request of the terminal a due to the fact that there is a distance measurement/angle measurement process with a higher priority currently, the terminal b gives a waiting duration in the reject message. The terminal a may initiate a distance measurement/angle measurement request after the waiting duration.

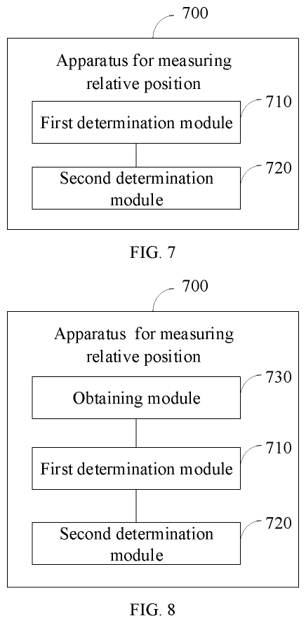

Corresponding to the method for measuring the relative position provided by the above embodiments, the present disclosure further provides an apparatus for measuring the relative position. Since the apparatus for measuring the relative position provided by the embodiment of the present disclosure corresponds to the method for measuring the relative position provided by the above embodiments, the embodiment of the method for measuring the relative position is also applicable to the apparatus for measuring the relative position provided in these embodiments, which is not described in detail in these embodiments. FIG. 7 to FIG. 10 are schematic structural diagrams of apparatuses for measuring a relative position according to embodiments of the present disclosure. The apparatus may be applied to a first terminal.

As shown in FIG. 7, the apparatus 700 for measuring the relative position includes a first determination module 710 and a second determination module 720.

The first determination module 710 is configured to determine, in response to obtained priority information in a relative position measurement request sent by a second terminal, a first priority of the relative position measurement request;

The second determination module 720 is configured to determine whether to receive the relative position measurement request according to the first priority.

In some embodiments, the priority information includes at least one of the following information: service-related information or service priority.

In some embodiments, the service-related information includes at least one of the following information: an operating system identification, an application identification, a service type, and a latency requirement.

In some embodiments, the second determination module 720 is configured to: receive the relative position measurement request in response to a currently ongoing relative position measurement process; or, terminate, in response to a second priority of an ongoing relative position measurement process being lower than the first priority, the ongoing relative position measurement process, and receive the relative position measurement request; or, reject the relative position measurement request in response to the second priority of the ongoing relative position measurement process being higher than or equal to the first priority.

In some embodiments, the relative position measurement request is carried by a PC5 RRC message or a PC5 schematic message.

In some embodiments, as shown in FIG. 8, the apparatus 700 may further include: an obtaining module 730, configured to obtain priority configuration information sent by a network element, where the configuration information includes service-related information and corresponding priority information.

In some embodiments, the configuration information further includes an applicable frequency band, and the first determination module 710 is further configured to determine, according to frequency bands respectively corresponding to the first terminal and the second terminal, whether to receive the relative position measurement request according to the first priority.

In some embodiments, the first determination module 710 is configured to: determine a frequency band corresponding to the second terminal in response to the obtained relative position measurement request sent by the second terminal; and determine the first priority of the relative position measurement request according to priority information in the relative position measurement request in response to the frequency bands corresponding to the second terminal and the first terminal being both the same as a frequency band in the configuration information.

In some embodiments, the first determination module 710 is configured to: determine a frequency band corresponding to the second terminal in response to the obtained relative position measurement request sent by the second terminal; and determine the first priority of the relative position measurement request according to priority information in the relative position measurement request in response to the frequency band corresponding to the second terminal being different from a frequency band in the configuration information.

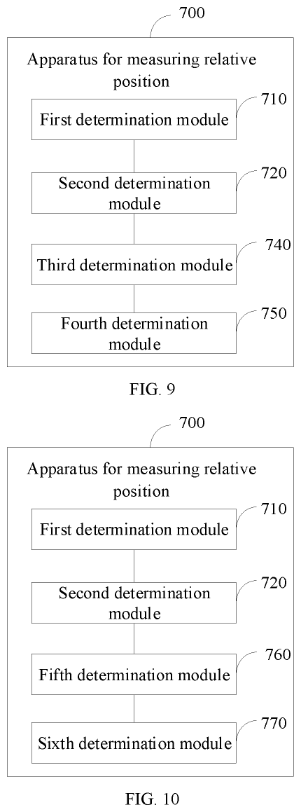

In some embodiments, as shown in FIG. 9, the apparatus may further include: a third determination module 740, configured to determine a priority of a first data packet related to the relative position measurement request; and a fourth determination module 750, configured to determine whether to transmit the first data packet according to the priority of the first data packet and a priority of a second data packet being transmitted for measuring the relative position.

In some embodiments, the fourth determination module 750 is configured to: reject to transmit the first data packet in response to the priority of the first data packet being lower than or equal to the priority of the second data packet; or, terminate transmission of the second data packet and start to transmit the first data packet in response to the priority of the first data packet being higher than the priority of the second data packet.

In some embodiments, as shown in FIG. 10, the apparatus may further include: a fifth determination module 760, configured to determine a priority of related interaction information of the relative position measurement request; and a sixth determination module 770, configured to determine a logical channel corresponding to the related interaction information according to the priority of the related interaction information and a priority of each logical channel.

In some embodiments, the apparatus may further include: a first return module, configured to return a rejection message to the second terminal in response to rejecting the relative position measurement request, where the rejection message includes a rejection reason.

In some embodiments, the apparatus may further include: a second return module, configured to return a rejection message to the second terminal in response to rejecting the relative position measurement request, where the rejection message includes a waiting duration to instruct the second terminal to initiate a relative position measurement request again after the waiting duration.

According to the apparatus for measuring the relative position of the embodiments of the present disclosure, the first priority of the relative position measurement request is determined in response to the obtained priority information in the relative position measurement request sent by the second terminal, and whether to receive the relative position measurement request is determined according to the first priority. Thus, the terminal determines whether to receive the new relative position measurement request according to the priority of the new relative position measurement request.

According to some embodiments of the present disclosure, the present disclosure further provides a network device and a readable storage medium.

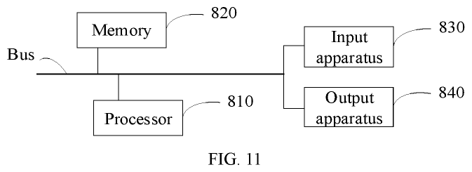

As shown in FIG. 11, it is a block diagram of network device according to some embodiments of the present disclosure. The network device is intended to represent various forms of digital computers, such as laptop computers, desktop computers, workbenches, personal digital assistants, servers, blade servers, large computers, and other suitable computers. The network device may also represent various forms of mobile apparatuses, such as personal digital processing, cellular telephones, smart phones, wearable devices, and other similar computing apparatuses. The components, their connections and relationships, and their functions shown here are merely examples, and are not intended to limit the implementations of the present disclosure described and/or claimed here.

As shown in FIG. 11, the network device includes one or more processors 810, a memory 820, and interfaces for connecting the components, including a high-speed interface and a low-speed interface. The various components are connected to each other using different buses, and may be installed on a common motherboard or otherwise installed as needed. The processor may process instructions executed within the network device, including instructions stored in or on the memory to display graphical information of the GUI on an external input/output apparatus, such as a display device coupled to the interface. In other embodiments, if needed, a plurality of processors and/or a plurality of buses may be used with a plurality of memories. Likewise, a plurality of network devices may be connected, each providing a portion of the necessary operations (e.g., as a server array, a set of blade servers, or a multi-processor system). In FIG. 11, one processor 810 is taken as an example.

The memory 820 is a non-transitory computer-readable storage medium provided by the present disclosure. Among them, the memory stores instructions executable by at least one processor, so that the at least one processor executes the method for measuring the relative position provided by the present disclosure. The non-transitory computer-readable storage medium of the present disclosure stores computer instructions for enabling a computer to perform the method for measuring the relative position provided by the present disclosure.

As a non-transitory computer-readable storage medium, the memory 820 may be configured to store non-transitory software programs, non-transitory computer-executable programs and modules, such as program instructions/modules (for example, the first determination module 710 and the second determination module 720 shown in FIG. 7) corresponding to the method for measuring the relative position in the embodiments of the present disclosure. The processor 810 executes various functional applications and data processing of the server by running non-transitory software programs, instructions, and modules stored in the memory 820, that is, implementing the method for measuring the relative position in the foregoing method embodiments.

The memory 820 may include a program storage region and a data storage region, where the program storage region may store an operating system and at least one application program needed by functions; and the data storage region may store data created according to the use of a positioned network device, etc. In addition, the memory 820 may include a high-speed random access memory, and may further include a non-transitory memory, such as at least one magnetic disk storage device, a flash memory device, or other non-transitory solid-state memory devices. In some embodiments, the memory 820 may optionally include memories remotely disposed relative to the processor 810, and the remote memories may be connected to the positioned network device through a network. Examples of the above network include, but are not limited to, the Internet, an enterprise intranet, a local area network, a mobile communication network, and a combination of them.

The network device for measuring the relative position may further include an input apparatus 830 and an output apparatus 840. The processor 810, the memory 820, the input apparatus 830, and the output apparatus 840 may be connected through a bus or in other manners. In FIG. 11, being connected through a bus is taken as an example.

The input apparatus 830 may receive input digital or character information, and generate key signal input related to user setting and function control of the positioned network device, such as a touch screen, a keypad, a mouse, a trackpad, a touchpad, an indicator rod, one or more mouse buttons, a trackball, a joystick and other input apparatuses. The output apparatus 840 may include a display device, an auxiliary lighting apparatus (e.g., an LED), a haptic feedback device (e.g., a vibration motor), or the like. The display device may include, but is not limited to, a liquid crystal display (LCD), a light emitting diode (LED) display, and a plasma display. In some embodiments, the display device may be a touch screen.

Various embodiments of the systems and techniques described here may be implemented in digital electronic circuit systems, integrated circuit systems, application specific integrated circuits (ASIC), computer hardware, firmware, software, and/or combinations of them. These various embodiments may include implementation in one or more computer programs. The one or more computer programs can be executed and/or interpreted on a programmable system including at least one programmable processor. The programmable processor can be a dedicated or general-purpose programmable processor that can receive data and instructions from a storage system, at least one input apparatus, and at least one output apparatus, and transmit the data and instructions to the storage system, at least one input apparatus, and at least one output apparatus.

These computing programs (also referred to as programs, software, software applications, or code) include machine instructions of a programmable processor, and these computing programs may be implemented using advanced processes and/or object-oriented programming languages, and/or assembler/machine languages. As used here, the terms “machine-readable medium” and “computer-readable medium” refer to any computer program product, device, and/or apparatus (e.g., magnetic disk, optical disk, memory, programmable logic device (PLD)) for providing machine instructions and/or data to a programmable processor, including a machine-readable medium that receives machine instructions as machine-readable signals. The term “machine-readable signal” refers to any signal used to provide machine instructions and/or data to a programmable processor.

To provide interaction with a user, the systems and techniques described here may be implemented on a computer having a display apparatus (e.g., a CRT (cathode ray tube) or an LCD (liquid crystal display) monitor) for displaying information to a user, and a keyboard and pointing apparatus (e.g., a mouse or trackball) through which the user may provide input to the computer. Other types of apparatuses may also be used to provide interaction with the user. For example, feedback provided to the user may be any form of sensory feedback (e.g., visual feedback, auditory feedback, or haptic feedback); and input from the user may be received in any form, including acoustic input, voice input, or haptic input.

The systems and techniques described here may be implemented in a computing system including a background component (e.g., as a data server), or a computing system (e.g., an application server) including a middleware component, or a computing system including a front-end component (e.g., a user computer with a graphical user interface or a web browser, through which the user may interact with embodiments of the systems and techniques described here), or a computing system including any combination of such background component, middleware component, or front-end component. The components of the system may be interconnected by any form or medium of digital data communication (e.g., a communication network). Examples of communication network include a local area network (LAN), a wide area network (WAN), and the Internet.

The computer system may include a client and a server. The client and the server are generally remote from each other and typically interact with each other through a communication network. The relationship between the client and the server is generated by computer programs running on respective computers and having a client-server relationship to each other.

According to the apparatus for measuring the relative position of the embodiments of the present disclosure, the first priority of the relative position measurement request is determined in response to the obtained priority information in the relative position measurement request sent by the second terminal, and whether to receive the relative position measurement request is determined according to the first priority. Thus, the terminal determines whether to receive the new relative position measurement request according to the priority of the new relative position measurement request.

It should be understood that the various forms of processes shown above may be used to reorder, add, or delete steps. For example, the steps described in the present disclosure may be executed in parallel, in sequence, or in different orders, as long as the expected results of the technical solution disclosed by the present disclosure can be achieved, which is not limited here.

The foregoing detailed description does not constitute a limitation on the protection scope of the present disclosure. Various modifications, combinations, sub-combinations and substitutions may be made according to design requirements and other factors in some embodiments of the present disclosure. Any modification, equivalent replacement and improvement made within the spirit and principle of the present disclosure should be included within the protection scope of the present disclosure.

1. A method for measuring a relative position, comprising:
determining, by a first terminal, in response to priority information in a relative position measurement request sent by a second terminal, a first priority of the relative position measurement request; and
determining, by the first terminal, whether to process the relative position measurement request according to the first priority.

2. The method according to claim 1, wherein the priority information comprises at least one of: service-related information and service priority.

3. The method according to claim 2, wherein the service-related information comprises at least one of: an operating system identification, an application identification, a service type, and a latency requirement.

4. The method of claim 1, wherein determining whether to process the relative position measurement request according to the first priority comprises:
processing the relative position measurement request in response to there is no currently ongoing relative position measurement process.

5. The method according to claim 1, wherein the relative position measurement request is carried by a PC5 radio resource control (RRC) message or a PC5 schematic message.

6. The method according to claim 1, further comprising:
obtaining priority configuration information sent by a network element, wherein the priority configuration information comprises service-related information and priority information corresponding to the service-related information.

7. The method according to claim 6, further comprising:
determining whether to process the relative position measurement request according to the first priority, according to frequency bands respectively corresponding to the first terminal and the second terminal.

8. The method according to claim 1, further comprising:
determining a priority of a first data packet related to the relative position measurement request; and
determining whether to transmit the first data packet according to the priority of the first data packet and a priority of a second data packet being transmitted for measuring a relative position.

9. The method according to claim 8, wherein determining whether to transmit the first data packet according to the priority of the first data packet and a priority of a second data packet being transmitted for measuring a relative position comprises:
rejecting to transmit the first data packet, in response to the priority of the first data packet being lower than or equal to the priority of the second data packet.

10. The method according to claim 1, further comprising:
determining a priority of related interaction information of the relative position measurement request; and
determining a logical channel corresponding to the related interaction information according to the priority of the related interaction information and a priority of each logical channel.

11. The method according to claim 1, further comprising:
returning a rejection message to the second terminal in response to rejecting the relative position measurement request, wherein the rejection message comprises a rejection reason.

12. The method according to claim 1, further comprising:
returning a rejection message to the second terminal in response to rejecting the relative position measurement request, wherein the rejection message comprises a waiting duration to instruct the second terminal to initiate a relative position measurement request again after the waiting duration.

13. (canceled)

14. A network device, comprising: a transceiver; a memory; and a processor, respectively connected to the transceiver and the memory, configured to control wireless signal transmission and reception of the transceiver by executing a computer executable instruction on the memory, and enable to implement a method for measuring a relative position, comprising:
determining, in response to priority information in a relative position measurement request sent by a second terminal, a first priority of the relative position measurement request; and
determining whether to process the relative position measurement request according to the first priority.

15. A non-transitory computer-readable storage medium, wherein the non-transitory computer-readable storage medium stores a computer-executable instruction, and after the computer-executable instruction is executed by a processor, a method for measuring a relative position is enabled to be implemented, the method comprising:
determining, in response to priority information in a relative position measurement request sent by a second terminal, a first priority of the relative position measurement request; and
determining whether to process the relative position measurement request according to the first priority.

16. The method of claim 1, wherein determining whether to process the relative position measurement request according to the first priority comprises:
terminating, in response to a second priority of an ongoing relative position measurement process being lower than the first priority, the ongoing relative position measurement process, and processing the relative position measurement request.

17. The method of claim 1, wherein determining whether to process the relative position measurement request according to the first priority comprises:
rejecting the relative position measurement request in response to a second priority of an ongoing relative position measurement process being higher than or equal to the first priority.

18. The method according to claim 8, wherein determining whether to transmit the first data packet according to the priority of the first data packet and a priority of a second data packet being transmitted for measuring a relative position comprises:
terminating transmission of the second data packet and starting to transmit the first data packet, in response to the priority of the first data packet being higher than the priority of the second data packet.

19. The method of claim 6, wherein determining, in response to the priority information in the relative position measurement request sent by the second terminal, the first priority of the relative position measurement request comprises:
determining a frequency band corresponding to the second terminal in response to the relative position measurement request sent by the second terminal; and
determining the first priority of the relative position measurement request according to the priority information in the relative position measurement request, in response to frequency bands corresponding to the second terminal and the first terminal being both the same as a frequency band in the priority configuration information.

20. The method of claim 6, determining, in response to the priority information in the relative position measurement request sent by the second terminal, the first priority of the relative position measurement request comprises:
determining a frequency band corresponding to the second terminal in response to the relative position measurement request sent by the second terminal; and
determining the first priority of the relative position measurement request according to the priority information in the relative position measurement request, in response to the frequency band corresponding to the second terminal being different from a frequency band in the priority configuration information.

21. The method of claim 1, wherein determining whether to process the relative position measurement request according to the first priority comprises:
determining to process the relative position measurement request in response to a number of simultaneous relative position measurement processes supported by the first terminal being greater than a number of ongoing relative position measurement processes.
